(19) United States
(12) Patent Application Publication
(10) Pub. No.: US 2018/0372258 A1
(43) Pub. Date: Dec. 27, 2018

(54) Pressurized High Voltage Skin Effect Heat Tracing System and Method

(71) Applicant: nVent Services GmbH, Schaffhausen (CH)

(72) Inventors: Wesley Dong, Belmont, CA (US); David G. Parman, San Ramon, CA (US); Paul Becker, San Carlos, CA (US)

(21) Appl. No.: 16/014,985

(22) Filed: Jun. 21, 2018

Related U.S. Application Data
(60) Provisional application No. 62/522,928, filed on Jun. 21, 2017.

(51) Int. Cl. F16L 53/34; F16L 59/14; F17D 1/18

(52) U.S. Cl. CPC F16L 53/34; F17D 1/18; F16L 59/14

(57) ABSTRACT

A skin effect heat tracing system including a heat tube and a heater cable with a core conductor and an electrical insulation layer surrounding the core conductor. The heater cable is sized to lie within the heat tube so that a gas-filled space is defined between an outer surface of the electrical insulation layer and an inner surface of the heat tube. During operation of the skin effect heat tracing system, the gas-filled space may be pressurized, by a gas source, above an external pressure outside the heat tube.

### RELATED APPLICATIONS

This application claims priority under 35 U.S.C. § 119 to U.S. Provisional Patent Application No. 62/522,928 filed on Jun. 21, 2017, the entire contents of which is incorporated herein by reference.

### BACKGROUND

The field of the invention is high voltage heating systems. More particularly, the invention relates to designs for high voltage skin effect heat tracing systems.

In the oil and gas industry, pipelines are generally heated over distances of many miles. Skin effect electric heat tracing systems may be suited for long transfer pipelines up to 12 miles (20 km) or 15 miles (25 km) per circuit. These skin effect heat tracing systems are generally engineered for a specific application, such as for material transfer lines, snow melting and de-icing, tank foundation heating, subsea transfer lines and prefabricated, pre-insulated lines. In a skin effect heat tracing system, heat is generated on the inner surface of a ferromagnetic heat tube that is thermally coupled to the pipe to be heat traced. An electrically insulated, temperature-resistant conductor is installed inside the heat tube and connected to the tube at a far end thereof. An alternating current (AC) is passed through the insulated conductor and returns through the heat tube.

At voltages above about 5 kV, the ferromagnetic heat tube of a skin effect heat tracing system is prone to the corona effect: a localized discharge resulting from transient gaseous ionization that occurs as a charge difference builds up between the surface of the tube and the surface of the insulated conductor inside the tube. Specifically, this localized discharge occurs when the charge difference exceeds the breakdown electric field for the gas disposed between the heat tube and the insulated conductor (about 3 V/μm for air). The corona effect can become a significant issue for longer pipelines having heat tracing systems that require a higher voltage potential to drive current because the higher voltage potential results in greater charge build-up between the heat tube of the skin effect tracing system and the insulated conductor surrounded by the heat tube. The accumulated static electricity can damage or prematurely age the insulation and other components of the heat tracing system and can sometimes result in electric arcing as accumulated static electricity discharges between the conductor and the heat tube.

It may be desirable to heat long pipelines (for example, on the order of 36 miles) and to handle voltages larger than 5 kV and up to 10 kV or higher. Thus, it may be desirable to use a system or method to reduce or eliminate the risk of partial discharge in heating systems.

### SUMMARY

The present invention overcomes the aforementioned drawbacks by providing a pressurized skin effect heat tracing system capable of withstanding continuous applied voltages above at least 5 kV with reduced corona effect.

In one aspect, the present invention provides a skin effect heat tracing system including a heat tube and a heater cable including a core conductor and an electrical insulation layer surrounding the core conductor. The heater cable may be sized to lie within the heat tube so that gas-filled space is defined between an outer surface of the electrical insulation layer and an inner surface of the heat tube. The gas-filled space may be pressurized above an external gas pressure outside the heat tube.

In some embodiments, the skin effect heat tracing system may include a sealed heater circuit that is substantially airtight and that comprises the heat tube and the heater cable. The sealed heater circuit may include a pull box, a front power connection box, an end termination box, and/or a splice box.

In some embodiments, the heater cable may be a round, unshielded heater cable, a round, shielded heater cable, a ribbed, unshielded heater cable, or a ribbed, shielded heater cable.

In some embodiments, the gas-filled space may be pressurized to between 20 and 30 pounds per square inch absolute.

In another aspect, the present invention provides a system that includes a carrier pipe, a skin effect heat tracing system disposed at a surface of the carrier pipe, and a gas source coupled to at least one component of the skin effect heat tracing system. The gas source may be configured to supply pressurized gas to the at least one component.

In some embodiments, the skin effect heat tracing system of the system may include a heater circuit in contact with the surface of the carrier pipe. The at least one component may include the heater circuit. The heater circuit may include a heat tube and a heater cable. The heater cable may include a core conductor and an electrical insulation layer surrounding the core conductor. The heater cable may be sized to lie within the heat tube so that gas-filled space is defined between an outer surface of the electrical insulation layer and an inner surface of the heat tube, the gas-filled space may be pressurized by the gas source above an external gas pressure outside the heat tube.

In some embodiments, the skin effect heat tracing system may further include an end termination box at an end of the carrier pipe and a pull box coupled to the end termination box via the heater circuit. The at least one component may further include at least one of the pull box and the end termination box. The heater circuit, the end termination box, and the pull box may be sealed so as to be substantially airtight.

In some embodiments, the system may further include a leak detection device coupled to the skin effect heat tracing system. The leak detection device may be configured to determine a leak rate of the at least one component.

In some embodiments, the system may further include a controller coupled to the skin effect heat tracing system. The controller may be configured to monitor an internal pressure of the at least one component and to instruct the gas source to supply the at least one component with additional pressurized gas in response to detecting that the internal pressure is less than a predefined pressure threshold.

In some embodiments, the pressurized gas may be air, nitrogen, argon, or sulfur hexafluoride.

In another aspect, the present invention provides a method of operating a skin effect heat tracing system. The method includes supplying, by a gas source, pressurized gas to one or more components of the skin effect heat tracing system to increase an internal gas pressure of the one or more components to be higher than an external gas pressure outside the one or more components.

In some embodiments, the method may further include, before supplying the pressurized gas, performing, with a leak detection device, a leak check on the one or more components to determine a leak rate.

In some embodiments, the method may further include determining, by the leak detection device, that the leak rate exceeds a predefined threshold, and sending, with the leak detection device, an alert to a controller coupled to the skin effect heat tracing system, the alert requesting maintenance of the skin effect heat tracing system in order to repair leaks.

In some embodiments, the method may further include asserting, by the leak detection device and in response to determining that the leak rate exceeds the predefined threshold, a flag indicative of an end condition, the flag instructing the controller to cease operation of the skin effect heat tracing system.

In some embodiments, the pressurized gas may be supplied by the gas source until the internal pressure of the one or more components is at a defined pressure level of between 20 to 30 pounds per square inch absolute.

In some embodiments, the method may further include determining, by a controller, that the internal gas pressure of the one or more components is less than a predefined pressure threshold, and instructing, by the controller, the gas source to supply additional pressurized gas to the one or more components.

In some embodiments, the one or more components may include a heater circuit having a heater cable disposed within a heat tube, a pull box, a front power connection box, an end termination box, and/or a splice box.

In some embodiments, the pressurized gas may include air, nitrogen, argon, or sulfur hexafluoride.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### DESCRIPTION OF THE DRAWINGS

FIG. 1 is a cross-sectional view of a heater cable in a heat tube, in accordance with an embodiment.

FIG. 2 is a perspective view of a pressurized skin effect heat tracing system, in accordance with an embodiment.

FIG. 3 is a graph illustrating partial discharge (in picocoulombs, pC) as a function of voltage (in volts, V) of various heat tracing system configurations at room temperature (20° C., 21° C.), 125° C., 130° C., and 150° C.

FIG. 4 is a flow chart illustrating a method of providing a pressurized skin effect heat tracing system for reducing the risk of partial discharge during system operation, in accordance with an embodiment.

FIG. 5 is a flow chart illustrating a method of pressurizing and monitoring a skin effect heat tracing system for reducing the risk of partial discharge during system operation, in accordance with an embodiment.

### DETAILED DESCRIPTION

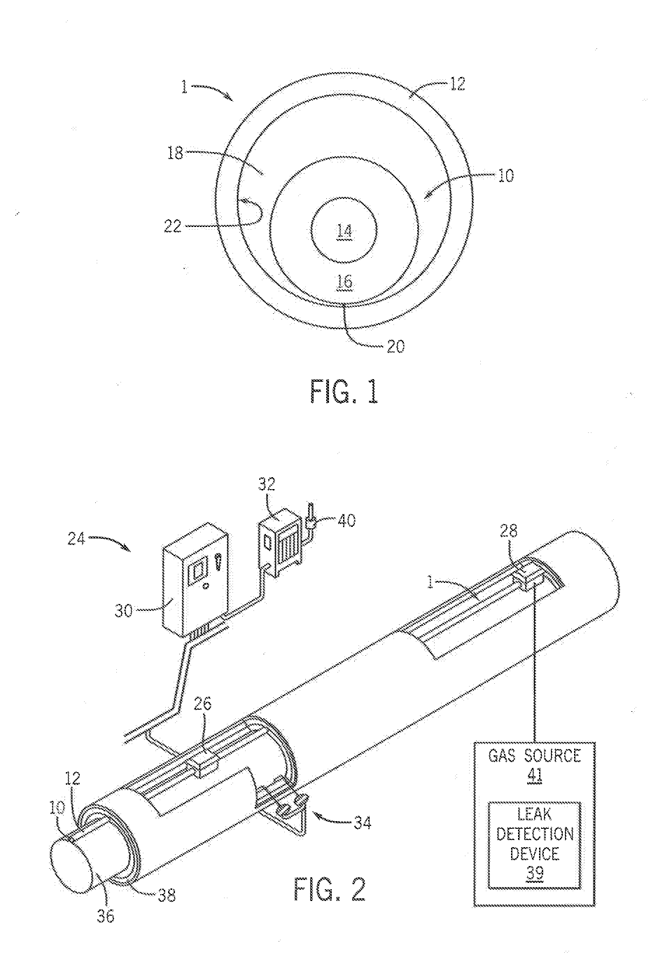

Generally, skin effect heat tracing systems include a heat tube with an internal heater cable. FIG. 1 shows a cross-section of a heat circuit 1, according to some embodiments (e.g., that may be used as part of a skin effect heat tracing system such as the skin effect heat tracing system 24 shown in FIG. 2). The heat circuit 1 includes a heat tube 12 and a heater cable 10 disposed within the heat tube 12. The heater cable 10 may include a core conductor 14 surrounded by an insulation layer 16. The heater cable 10 and the heat tube 12 may be connected to a power source (e.g., capable of providing 5 kilovolts (kV) or more) at one end and to each other at another end, forming a heat circuit. While the heater cable 10 is shown to be a round, unshielded heater cable, other heater cable configurations may be used in other embodiments. For example, in some embodiments, a shielded heater cable configuration may be used in which the heater cable 10 includes a shielding (e.g., conductive or semiconductive) jacket or one or more shielding layers (e.g., semiconductive layers) disposed around the insulation layer 16. In other embodiments, a ribbed heater cable configuration may be used in which the heater cable 10 includes an insulation layer 16 having extruded portions that form “ribs.” In still other embodiments, a shielded, ribbed heater cable configuration may be used in which the heater cable 10 includes both shielding and a ribbed insulation layer 16.

The heater cable 10 can be surrounded by gas 18 (sometimes referred to herein as “gas-filled space” 18) except at a point 20, at which the heater cable 10 is in contact with an inner surface 22 of the heat tube 12. For example, the gas 18 may be air, nitrogen, argon, sulfur hexafluoride (SF₆), or any other applicable gas that may be introduced to the space between the heater cable 10 and the heat tube 12. The positioning of the heater cable 10 within the heat tube 12 produces non-uniform electrical fields when electrical power is applied to the heater cable 10, with the highest electric field being located where the heater cable 10 contacts the heat tube 12 (i.e., at point 20). The insulation layer 16 may be, for example, made from polyethylene, perfluoroalkoxy resin (PFA), ethylene propylene rubber (EPR), ethylene propylene diene monomer (EPDM) rubber, or silicon rubber. Electric charge accumulates on the outer surface of the insulation layer 16 during operation of the skin effect heat tracing system. If the voltage between the heater cable 10 and the heat tube 12 exceeds the breakdown voltage for the gas in the gas-filled space 18, the accumulated electric charge discharges as corona (that is, partial discharge, or PD). More specifically, PD occurs primarily at the point 20 due to the charge differential between the outer surface of the insulation 16 and the inner surface 22 of the heat tube 12 (which may be electrically grounded), and further due to the relatively close proximity of these two surfaces. Protracted PD can erode the solid insulation 16 and eventually break down the insulation 16 this point 20. Protracted PD also tends to initiate defects (voids, imperfections, contaminants, etc.) in the heat tube 12. Thus, it may be advantageous to reduce PD in order to reduce the risk of insulation erosion and tube defects. Furthermore, reducing PD decreases the risk of igniting flammable vapors or dusts that may be present near the heat tube 12. Also, reducing PD decreases the effects of PD-generated ozone. In particular, ozone generated by PD can react with gas (e.g., nitrogen in the air) and moisture to create nitric acid, which increases corrosion of steel and other metal alloys, and, furthermore, ozone may have a deleterious effects on wire insulation (e.g., the insulation 16).

To limit the risk of this corona effect and potential electrical arcing events, conventional skin effect heat tracing systems generally limit heat circuit lengths to about 25 Kilometers (15 miles) from a single source using supply voltages approaching 5 kV. Embodiments of the present invention, in contrast, provides a skin effect heat tracing system that can operate at over 5 kV such as at 7.5 kV, 10 kV, or higher, and at circuit lengths over 25 Kilometers with comparatively less PD, which is enabled via the pressurization of gasses within one or more components the skin effect heat tracing system. As will be described in greater detail below, increasing system pressure reduces PD, which allows the system to operate at higher voltages and further allows for increased circuit lengths to be realized.

Accordingly, FIG. 2 illustrates a skin effect heat tracing system 24 (sometimes referred to herein simply as the “system” 24) of some embodiments of the invention. The system 24 may include a ferromagnetic heat tube 12, one or more heater cables 10 (such as the heater cable 10 of FIG. 1), one or more pull boxes 26, an end termination box 28, a front power connection box (not shown), a control panel 30, a transformer 32, and one or more splice boxes (not shown). The system 24 may also include one or more resistance temperature detectors (RTDs) 34, which may be disposed at one or more locations along a carrier pipe 36 in order to measure the temperatures of the carrier pipe 36 at these locations. Generally, the system 24 may operate to heat the carrier pipe 36, which can be used for transporting oil, gas, or other heavy fluids.

As shown in FIG. 2, the heat tube 12 (e.g., which may be a tube formed from metal such as carbon steel) is positioned against (e.g., in physical contact with) the carrier pipe 36 and the heat tube 12 and the carrier pipe 36 are surrounded by thermal insulation (and/or cladding) 38. The heater cable 10 lies inside the heat tube 12 and both the heater cable 10 and the heat tube 12, or multiple segments thereof, extend from the end termination box 28 to the front power connection box (not shown), which may be disposed at an end of the carrier pipe 36 opposite from the end termination box 28. The pull boxes 26 may be dispersed along the length of the heat tube 12 between the end termination box 28 and the front power connection box and can connect (e.g., electrically connect) individual heat circuits (i.e., individual sections of the heater cable 10 and the heat tube 12).

More specifically, as shown in FIG. 2, the heater cable 10 and the heat tube 12 may be powered by a power source 40 and a transformer 32. When power is applied to the heater cable 10 in this way, the heater cable 10 converts the electric power to thermal energy which heats the carrier pipe 36. In particular, the heater cable 10 and the heat tube 12 may be in electrical communication with the control panel 30 and the transformer 32 at the pull boxes 26 and the front power connection box, and the control panel 30 and the transformer 32 are in further electrical communication with the power source 40. Accordingly, the heater cable 10 and the heat tube 12 are connected to the power source 40 at one end (e.g., at a pull box 26 or the front power connection box) and to each other at another end (e.g., at an adjacent pull box 26 or the end termination box 28), forming an individual heat circuit 1.

The pull boxes 26 can allow the individual heat circuits to be modified, replaced, or serviced without disturbing the insulation 38. Heat circuit lengths may be determined by a combination of cable size, cable voltage, temperature rating, heat tube size, and attachment method. Additionally, one or more splice boxes may be dispersed between adjacent pull boxes 26 to protect a splice between two heater cables 10 in a single heat circuit segment. However, in some embodiments, heater cables 10 may be long enough to travel between pull boxes 26 such that the splice boxes are unnecessary.

Generally, the internal gas pressure in components of the system 24 may initially be at atmospheric pressure, nominally 14.7 pounds per square inch absolute (psia). According to some embodiments, during heating operations, one or more components of the system 24 may be pressurized above atmospheric pressure, such as to approximately 20-30 psia. In other words, one or more components of the system 24 may have an internal pressure of about 5-15 pounds per square inch gauge (psig) compared to an external pressure of the system 24.

In some embodiments, the components may be subjected to internal gas pressurization via a gas source 41, which may include a compressor, a pressurized gas tank, or other suitable pressurizing tools. While in the present example, the gas source 41 is shown to be coupled to the system 24 through the end termination box 28, it should be understood that, in other embodiments, the gas source 41 may be coupled to the system 24 at other locations. For example, the gas source 41 may instead be coupled to one of the splice boxes, the front power connection box, directly to the heat tube 12, one of the pull boxes 26, or any other applicable component of the system 24 to supply pressurized gas to the system.

As another illustrative, non-limiting example, in some embodiments of the system 24, voltages observed at individual heat circuits located near the end termination box 28 may be lower than voltages observed at individual heat circuits located elsewhere along the carrier pipe 36, and PD may be less likely to occur at these lower voltage locations. Thus, in some embodiments, only the front power connection box and selected heat circuits, pull boxes 26, and/or splice boxes located more than a predefined distance from the end termination box 28 may be sealed and pressurized, while those located less than this predefined distance from the end termination box 28 (e.g., components at less risk of experiencing PD) may remain unsealed and unpressurized. By only pressurizing components at comparatively higher risk of experiencing PD, unnecessary pressurization of system components with low or zero PD risk may be avoided, thus reducing the likelihood of losing gas due to leaks.

Additionally, in some embodiments, the gas source 41 may include a leak detection device 39, which may check the portion of the system 24 to be pressurized in order to determine whether leaks are present in that portion. In alternate embodiments, this leak detection may be performed using a leak detection device separate from the gas source 41. The leak detection device 39 may also determine whether the leak rate of the system 24 is significant enough to impede or prevent the effective pressurization of the system 24 (e.g., whether the detected leak rate exceeds a predetermined threshold). If significant leaking is detected, the leak detection device 39 may provide an alert to the control panel 30 (e.g., to a computer controller or processor in the control panel 30) indicating that maintenance should be performed on the system 24 in order to repair leaks before performing heating operations with the system 24.

Generally, at least the heat tube 12 of the system 24 can be pressurized—that is, each end of the heat tube 12 may be sealed so that the space 18 defined between the heater cable 10 and the heat tube 12, as shown in FIG. 1, may be pressurized (e.g., by the gas source 41) to a pressure exceeding the external gas pressure (e.g., atmospheric pressure) outside the heat tube 12. In one embodiment, only the heat tube 12 may be pressurized (i.e., the ends of the heat tube 12 may be sealed to maintain the increased pressure). According to another embodiment, the heat tube 12, the splice boxes, and the pull boxes 26 may be pressurized (i.e., pressurizing and sealing the splice boxes and the pull boxes 26 effectively keeps the heat tube 12 pressurized). According to yet another embodiment, the heat tube 12, the splice boxes, the pull boxes 26, the end termination box 28, and the front power connection box may be pressurized. According to a further embodiment, the entire system 24 may be pressurized, including the heat tube 12, the splice boxes, the pull boxes 26, the end termination box 28, the front power connection box, and all power connections. Furthermore, other combinations of pressurized components may be within the scope of this invention even though not specifically discussed herein.

To accomplish this pressurization, the components of at least a portion of the system 24 (e.g., the portion that is to be pressurized) may be effectively sealed so that these components are substantially airtight (i.e., airtight or of such a low gas leak rate that pressurizing 5-15 psi is technically and economically feasible). For example, all connection joints of the heat tube 12 may be made with airtight welds to ensure the heat tube 12 is substantially airtight. The pull boxes 26 may include covers that are sealed, for example with silicone, such as room-temperature-vulcanization (RTV) silicone, or other types of sealants or via other sealing methods. The end termination box 28 and the front power connection box may be sealed, for example, with gaskets or other sealing methods. In addition, or alternatively, one or more of the heat tubes 12 may be sealed by cable glands (not shown) at locations where the heater cables 10 enter and exit the heat tubes 12 (e.g., at the end termination box 28, the front power connection box, and/or the splice boxes).

As described above, reducing PD is advantageous in skin effect heat tracing systems, and pressurizing the system 24 decreases the tendency for PD) to occur. More specifically, as a gas is pressurized in an electric field, the mean free path of an electron moving in the electric field before it collides with a gas molecule is shortened due to the higher number of gas molecules present. In other words, increasing the pressure increases the number of atoms/molecules in a static (e.g., not dynamic), confined volume, which increases the chance of an electron colliding with those atoms/molecules as it moves across that static volume (thereby decreasing the free mean path of the electron). Decreasing the mean free path in this way reduces the collision energy of the electron and molecule. As a given gas molecule must receive a defined amount of energy before ionizing, this reduction in collision energy decreases the likelihood that the gas molecule will ionize and generate a partial discharge.

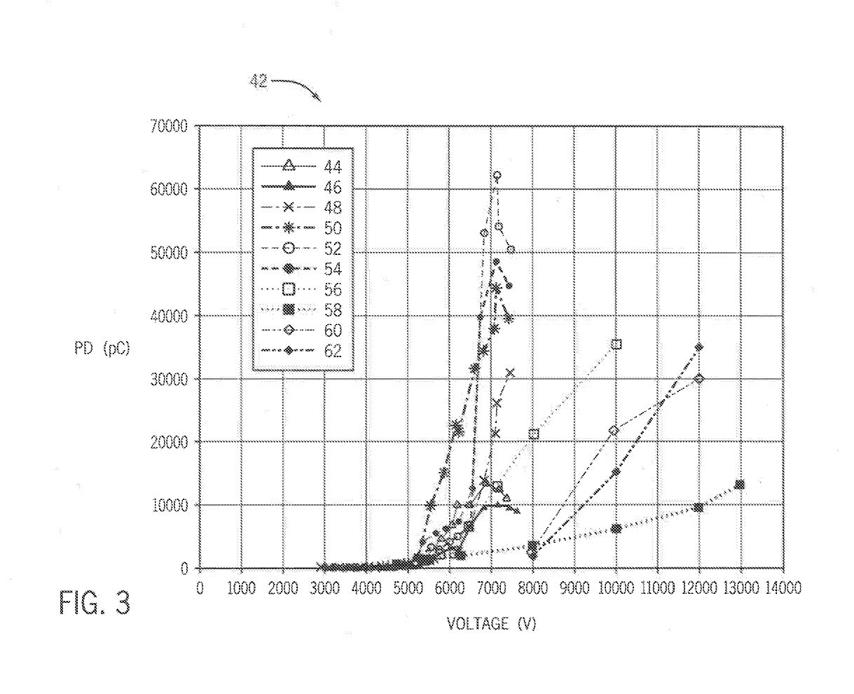

For example, it has been shown that PD is proportional to absolute temperature such that, at a constant pressure, increasing temperatures correspond to a reduction of the number of gram moles of gas present. As such, increasing temperatures correlate to increasing PD current. In a general experiment, PD increased by about three to five times as temperature increased from 20 degrees Celsius (° C.) to 150° C. In another heat tube experiment, PD increased with increased heat tube temperature, as shown in the graph 42 of FIG. 3. More specifically, FIG. 3 shows PD (in picocoulombs, pC) as a function of voltage (in volts, V) at room temperature (20° C., 21° C.), 125° C., 130° C., and 150° C. of heat circuits having heater cables with various end treatments (e.g., rounded or ribbed insulators) and various welded couplings, illustrating the correlation between increasing PD and increasing voltage. In FIG. 3, lines 44, 48, and 52 illustrate PD as a function of voltage for a first heater cable at 21° C., 125° C., and 150° C., respectively. Lines 46, 50, and 54 illustrate PD as a function of voltage for a second heater cable at 21° C., 125° C., and 150° C., respectively. Lines 56 and 58 illustrate PD as a function of voltage for a third ribbed silicone heater cable at 20° C. and 130° C., respectively. Lines 60 and 62 illustrate PD as a function of voltage for a fourth ribbed heater cable and a fifth ribbed heater cable, respectively, at 20° C.

As shown in FIG. 3, at greater than 5 kV, PD increases with increasing tube temperature for all heater cable configurations. This increased PD is likely due to the increased gas temperature (e.g., of gasses in space 18 of FIG. 1, or of other gasses enclosed by the skin effect heat tracing system), and the consequent reduced number of gas molecules present at higher temperatures. Conversely, in accordance with embodiments of the invention, PD may be decreased by increasing gas pressure. More specifically, increasing pressure will increase the number of gas molecules, thus decreasing the mean free electron path and reducing collision energy and the likelihood of PD. An increase in the number of molecules is related to the initial and final conditions within the heat tube 12 as follows:

n₂/n₁∝P₂/P₁

according to the Ideal Gas Law, PV=nRT, where P=absolute pressure. Thus, in applications where a conventional, unpressurized skin effect heat tracing system operates around 150° C., according to FIG. 3, the observed PD is about five times that of PD at room temperature (˜21° C.). In order to reduce PD to the expected room temperature value, the pressure would need to be increased by

$$\frac{{P}_{2}}{{P}_{1}} ∝ \frac{{T}_{2}}{{T}_{1}} ∝ \frac{423 K}{293 K} = 1.44$$

$${P}_{2} = 1.44 * 14.7 = 21.2 psia or 6.5 psig$$

Thus, at a pressure of about 6.5 psig, and 150° C., PD could be reduced by a factor of four compared to ambient pressure levels. Returning to FIG. 2, heat tubes 12 would generally not be adversely affected by this level of pressure change (e.g., in some embodiments heat tubes 12 are nominally rated to 4500 psig internal pressure at 150° C. and, thus, a 6.5 psig difference is a relatively low pressure that would not affect the tubing or fittings).

Accordingly, the pressurization of skin effect heat tracing system 24 can reduce the risk of PD and, thus, improve the scope of the applications for which the system 24 can be used. More specifically, embodiments of the present invention reduce electrical fields (and partial discharge thereby) in gas around the heater cable 10 located within the electrically conductive tube 12 (e.g., which may be grounded) in a quantifiable fashion by pressurizing the tube 12 and/or other components of the system 24. Since electron collision energy is decreased via this pressurization, higher voltages can be applied to the heater cable 10 with comparatively reduced risk of PD. Consequently, the skin effect heat tracing system 24 of the present invention can include a heat circuit deployed with longer distances between line lead connections compared to conventional, unpressurized systems, such as greater than 15 miles, up to 36 miles, or greater than 36 miles, and at higher voltages, such as above 5 kV, up to 10 kV, or higher than 10 kV.

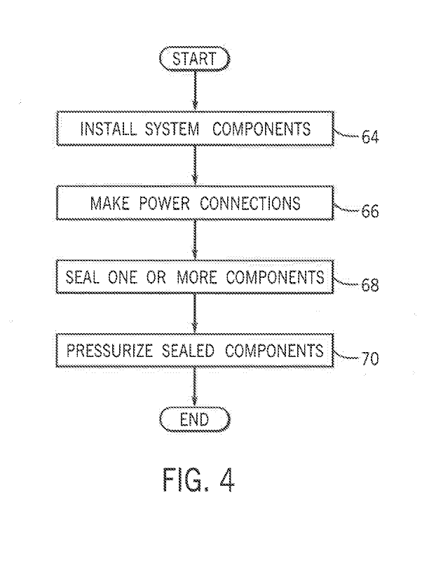

In light of the above, some embodiments of the invention further include a method of providing a pressurized skin effect heat tracing system 24 to reduce the risk of PD during operation. FIG. 4 shows a method for assembling a pressurized heat effect tracing system (such as the system 24 of FIG. 2). At step 64, components of the system 24 may be installed, such as one or more heat circuits (e.g., heat circuit 1 including the heat tube 12 and the heater cable 10 of FIGS. 1 and 2), one or more pull boxes (e.g., pull boxes 26 of FIG. 2), a front power connection box, an end termination box (e.g., the end termination box 28 of FIG. 2), and, optionally, one or more splice boxes, with respect to a carrier pipe (e.g., the carrier pipe 36 of FIG. 2).

At step 66, power connections may be made between a subset of the components that are electrically powered and a power source (e.g., connecting the heat tube 12 and the heater cable 10 to the power source 40 via the pull boxes 26, the front power connection box, the end termination box 28, and the control panel 30 and the transformer 32 of FIG. 2).

At step 68, one or more components of the system, such as heat tubes, pull boxes, splice boxes, the front power connection box, and/or the end termination box, may be made substantially airtight via one or more sealing methods, as described above.

Finally, at step 70, the one or more components, now sealed, may be pressurized (e.g., via a gas source such as gas source 41 of FIG. 2) such that their internal gas pressure is higher than an external gas pressure outside the components.

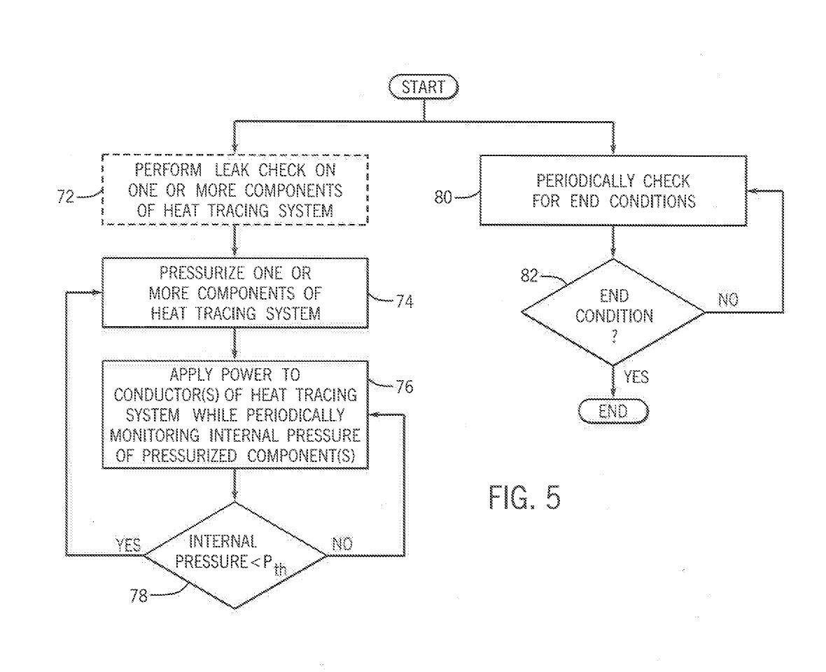

FIG. 5 shows a method, according to some embodiments, by which components of a skin effect heat tracing system (e.g., system 24 of FIG. 2) may be dynamically pressurized during heating operations. It should be understood that, upon initiating this method, two parallel processes may be executed, the first process including steps 72-78, related to leak checking and iteratively pressurizing and monitoring the pressure of the system, and the second process including steps 80 and 82, related to checking for one or more predefined end conditions and ending the method when such a predefined end condition has been detected. It should further be noted that some or all of the steps of the method of FIG. 5 may be performed using one or more computer processors, which, according to various examples, may be housed within the control panel 30, may be part of a controller (e.g., a computer controller) housed within the control panel 30, or may be part of a computer server communicatively coupled to the control panel 30 via an electronic communications network such as the internet. Some or all of the instructions for performing the method of FIG. 5 may be software instructions that may be at least partially stored on a non-transitory computer-readable medium coupled to (e.g., in electronic communication with) the one or more computer processors.

Beginning with the first process, at step 72, a leak check may optionally be performed using a leak detection device (e.g., leak detection device 39 of FIG. 2) in order to determine whether the leak rate of the components (e.g., sealed components) of the system that are to undergo pressurization. As described above, these components may include one or more heat circuits (e.g., heat circuit 1 including the heat tube 12 and the heater cable 10 of FIGS. 1 and 2), one or more pull boxes (e.g., pull boxes 26 of FIG. 2), a front power connection box, an end termination box (e.g., the end termination box 28 of FIG. 2), and/or, one or more splice boxes. The leak detection device may determine the leak rate for the components and may further determine whether the leak rate is significant enough to impede or prevent the effective pressurization of the system. For example, the leak detection device may supply pressurized gas to the system in order to pressurize the system to a predefined internal pressure. The leak detection device may then cease supplying the pressurized gas and may monitor the rate at which the internal pressure of the system decreases in order to determine the leak rate. The leak detection device may then compare the determined leak rate to a predefined threshold (e.g., which may be preset or which may be manually selected by a user). If the determined leak rate exceeds the predefined threshold, the leak detection device may provide an alert to a controller for the system (e.g., the control panel 30, or a computer controller or processor in the control panel 30, of FIG. 2) indicating that maintenance should be performed on the system in order to repair leaks before performing heating operations with the system. The determined leak rate exceeding the predefined threshold may be an end condition, detectable at step 80, and may result in the cessation of the method without proceeding to step 74. For example, upon determining that the leak rate exceeds the predefined threshold, the leak detection device or the controller may assert a flag indicative of the end condition, which may instruct the controller to cause operation of the skin effect heat tracing system 24 to cease. Otherwise, if the determined leak rate does not exceed the predefined threshold, the method may proceed to step 74.

At step 74, a gas source (e.g., the gas source 41 of FIG. 2) may pressurize one or more components (e.g., sealed components) of the system to a predefined internal pressure, which may exceed the external pressure outside of these components. For example, the components of the system may be pressurized to an internal pressure of approximately 20-30 psia. In another example, the components of the system may be pressurized to an internal pressure of approximately 5-15 psig compared to an external pressure of the system. In some embodiments, the controller may instruct or control the gas source to automatically pressurize the one or more components. Alternatively, in some embodiments, the controller may provide instructions for a user to manually control the gas source to pressurize the one or more controllers.

At step 76, a power source (e.g., power source 40 of FIG. 2) may apply electric power to one or more conductors (e.g., the core conductor 14 of the heater cable 10 of FIG. 1) while one or more pressure sensors periodically monitor the internal pressure of the components that were pressurized at step 74. For example, the controller may be in electronic communication with the one or more pressure sensors. The controller may analyze pressure data generated when the one or more pressure sensors periodically monitor the internal pressure of the components of the system to determine whether the internal pressure of the components of the system has fallen below a predefined pressure threshold, Pₜₕ.

At step 78, if the controller determines that the internal pressure of the components of the system has fallen below Pₜₕ, the method returns to step 74 so that the components may be re-pressurized by the gas source. In other words, when the sensed pressure falls below Pₜₕ, the controller instructs the gas source to re-pressurize the components. Otherwise, if the internal pressure of the components of the system remains above Pₜₕ, the method returns to step 76 and power continues to be applied to the conductors, enabling the continued normal operation of the skin effect heat tracing system. In some embodiments, the controller can further analyze pressure data over time and generate an alert if the analyzed data indicates a leak (e.g., if the system drops below Pₜₕ a certain number of times over a time period or if the system drops below Pₜₕ within a pre-determined time period after being re-pressurized).

Turning now to the second process, at step 80, the controller may periodically check for one or more end conditions while steps 72-78 are being performed. For example, end conditions may include the detection that the leak rate of the system exceeds a predefined threshold, the detection of a user- or system-provided instruction to cease operation of the skin effect heat tracing system, the detection that power is no longer being applied to the skin effect heat tracing system. As an example, if it is detected that the operating voltage of a given heat circuit is reduced below approximately 5 kV, the skin effect heat tracing system may automatically stop applying pressurized gas to that heat circuit.

At step 82, if the controller has not detected an end condition the method returns to step 80. Otherwise, if the controller has detected an end condition, the method ends. In some embodiments, ending the method may include ceasing the application of power and pressurized gas to the system. In some embodiments, ending the method may also further include depressurizing the components of the system. Alternatively, in some embodiments, the method of FIG. 5 may only include steps 72-78 (that is, without steps 80-82).

It should be noted that, for embodiments having multiple, separately sealed heat circuits, some heat circuits may remain off (e.g., not receiving power) while other heat circuits receive power, such that heat may be applied only to selected sections of the carrier pipe. In such embodiments, the gas source may be switchably connected (e.g., through one or more valves, which may be controlled by a controller of the control panel) to each of the sealed heat circuits, and may supply pressurized gas to only those heat circuits that are active (e.g., that are receiving power). In this way, gas is not wasted on inactive heat circuits that may not require pressurization

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A skin effect heat tracing system comprising:
a heat tube; and
a heater cable including a core conductor and an electrical insulation layer surrounding the core conductor, the heater cable sized to lie within the heat tube so that gas-filled space is defined between an outer surface of the electrical insulation layer and an inner surface of the heat tube, the gas-filled space being pressurized above an external gas pressure outside the heat tube.

2. The skin effect heat tracing system of claim 1, further comprising:
a sealed heater circuit that is substantially airtight and that comprises the heat tube and the heater cable.

3. The skin effect heat tracing system of claim 2, wherein the sealed heater circuit further comprises a sealed component selected from the group consisting of: a pull box, a front power connection box, an end termination box, and a splice box.

4. The skin effect heat tracing system of claim 1, wherein the heater cable is selected from the group consisting of: a round, unshielded heater cable, a round, shielded heater cable, a ribbed, unshielded heater cable, and a ribbed, shielded heater cable.

5. The skin effect heat tracing system of claim 1, wherein the gas-filled space is pressurized to between 20 and 30 pounds per square inch absolute.

6. A system comprising:
a carrier pipe;
a skin effect heat tracing system disposed at a surface of the carrier pipe; and
a gas source coupled to at least one component of the skin effect heat tracing system, the gas source being configured to supply pressurized gas to the at least one component.

7. The system of claim 6, wherein the skin effect heat tracing system comprises:
a heater circuit in contact with the surface of the carrier pipe, wherein the at least one component comprises the heater circuit, the heater circuit comprising:
a heat tube; and
a heater cable including a core conductor and an electrical insulation layer surrounding the core conductor, the heater cable sized to lie within the heat tube so that gas-filled space is defined between an outer surface of the electrical insulation layer and an inner surface of the heat tube, the gas-filled space being pressurized by the gas source above an external gas pressure outside the heat tube.

8. The system of claim 7, wherein the skin effect heat tracing system further comprises:
an end termination box at an end of the carrier pipe; and
a pull box coupled to the end termination box via the heater circuit, wherein the at least one component further comprises at least one of the pull box and the end termination box.

9. The system of claim 8, wherein the heater circuit, the end termination box, and the pull box are sealed so as to be substantially airtight.

10. The system of claim 6, further comprising:
a leak detection device coupled to the skin effect heat tracing system, the leak detection device being configured to determine a leak rate of the at least one component.

11. The system of claim 6, further comprising:
a controller coupled to the skin effect heat tracing system, the controller being configured to monitor an internal pressure of the at least one component and to instruct the gas source to supply the at least one component with additional pressurized gas in response to detecting that the internal pressure is less than a predefined pressure threshold.

12. The system of claim 6, wherein the pressurized gas is selected from the group consisting of: air, nitrogen, argon, and sulfur hexafluoride.

13. A method of operating a skin effect heat tracing system, the method comprising:
supplying, by a gas source, pressurized gas to one or more components of the skin effect heat tracing system to increase an internal gas pressure of the one or more components to be higher than an external gas pressure outside the one or more components.

14. The method of claim 13, further comprising:
before supplying the pressurized gas, performing, with a leak detection device, a leak check on the one or more components to determine a leak rate.

15. The method of claim 14, further comprising:
determining, by the leak detection device, that the leak rate exceeds a predefined threshold; and
sending, with the leak detection device, an alert to a controller coupled to the skin effect heat tracing system, the alert requesting maintenance of the skin effect heat tracing system in order to repair leaks.

16. The method of claim 15, further comprising:
asserting, by the leak detection device and in response to determining that the leak rate exceeds the predefined threshold, a flag indicative of an end condition, the flag instructing the controller to cease operation of the skin effect heat tracing system.

17. The method of claim 13, wherein the pressurized gas is supplied by the gas source until the internal pressure of the one or more components is at a defined pressure level of between 20 to 30 pounds per square inch absolute.

18. The method of claim 13, further comprising:
determining, by a controller, that the internal gas pressure of the one or more components is less than a predefined pressure threshold; and
instructing, by the controller, the gas source to supply additional pressurized gas to the one or more components.

19. The method of claim 13, wherein the one or more components comprise at least one sealed component selected from the group consisting of: a heater circuit having a heater cable disposed within a heat tube, a pull box, a front power connection box, an end termination box, and a splice box.

20. The method of claim 13, wherein the one or more components that the gas source supplies pressurized gas to are located more than a predefined distance away from an end termination box of the skin effect heat tracing system.
